(19) United States
(12) Patent Application Publication
(10) Pub. No.: US 2014/0365215 A1
(43) Pub. Date: Dec. 11, 2014

(54) METHOD FOR PROVIDING SERVICE BASED ON MULTIMODAL INPUT AND ELECTRONIC DEVICE THEREOF

(71) Applicant: Samsung Electronics Co., Ltd., Gyeonggi-do (KR)

(72) Inventor: Kyung-Tae KIM, Gyeonggi-do (KR)

(73) Assignee: Samsung Electronics Co., Ltd., Gyeonggi-do (KR)

(21) Appl. No.: 14/297,042

(22) Filed: Jun. 5, 2014

(30) Foreign Application Priority Data
Jun. 5, 2013 (KR) 10-2013-0064943

(51) Int. Cl. G10L 15/26

(52) U.S. Cl. CPC G10L 15/26
USPC 704/235

(57) ABSTRACT

A method for operating an electronic device is provided. The method includes receiving a voice signal and an input, extracting data corresponding to the input, converting the voice signal to text data, setting an association relationship between the converted text data and the extracted data, and generating a response for the voice signal based on the converted text data, the extracted data, and the set association relationship.

### PRIORITY

This application claims priority under 35 U.S.C. §119 to a Korean Patent Application filed on Jun. 5, 2013 in the Korean Intellectual Property Office and assigned Ser. No. 10-2013-0064943, the entire contents of which are incorporated herein by reference.

### BACKGROUND

1. Field of the Invention

The present invention generally relates to a method and apparatus for providing service based on multimodal input.

2. Description of the Related Art

With provisioning of a virtual assistant service capable of inputting natural language, various services are provided which improve user convenience using natural language input. Since natural language does not comply with completely defined rules or forms, it is difficult to completely understand and process natural language in an electronic device. Therefore, it is difficult for a user to obtain a desired result using only natural language input with an electronic device.

To address the above-mentioned problem, multimodal input has been attempted. Multimodal input is a scheme for receiving and processing voice formulated in natural language and non-voice input, such as a touch, or process, which allows a user to precisely and specifically input information to be transferred to a terminal. In U.S. Pat. No. 7,137,126, a multimodal event including voice is input through a multimodal conversational user interface (CUI) in order for a user to query a dialog system.

Since a user must clearly set a relationship between multimodal input data in an electronic device supporting an existing multimodal input method, the user is inconvenienced. Therefore, there is a need for a method and apparatus for obtaining a desired result without requiring a user to set a relationship between multimodal input data in the electronic device.

### SUMMARY OF THE INVENTION

The present invention has been made to address at least the above-mentioned problems and/or disadvantages and to provide at least the advantages described below. Accordingly, an aspect of the present invention is to provide a method and apparatus for providing a service using data input through various input units of an electronic device.

Another aspect of the present invention is to provide a method and apparatus for analyzing a relationship between input data by using input time information of data input through various input units of an electronic device.

Another aspect of the present invention is to provide a method and apparatus for setting a relationship between a plurality of demonstrative pronouns and data input through other input units when there is a plurality of demonstrative pronouns in a natural language query input to an electronic device.

Another aspect of the present invention is to provide a method and apparatus for determining the intent of a demonstrative pronoun included in a natural language query based on data input through other input units of an electronic device.

According to an aspect of the present invention, a method of operating an electronic device includes receiving a voice signal and an input; extracting data corresponding to the input; converting the voice signal to text data; setting an association relationship between the converted text data and the extracted data; and generating a response for the voice signal based on the converted text data, the extracted data, and the set association relationship.

According to another aspect of the present invention, a method of operating an electronic device includes receiving a voice signal; storing first time information at which the voice signal is received; receiving an input; storing second time information corresponding to the input; extracting data corresponding to the input; converting the voice signal to text data; and generating a response for the voice signal based on the text data, the first time information, the extracted data, and the second time information.

According to another aspect of the present invention, an electronic device includes a voice input device for receiving a voice signal; another input device for receiving an input; and a control unit for extracting data corresponding to the input, converting the voice signal to text data, setting an association relationship between the text data and the extracted data, and generating a response for the voice signal based on the text data, the extracted data, and the set association relationship.

According to another aspect of the present invention, an electronic device includes a voice input device for receiving a voice signal; an input device for receiving an input; and a control unit for acquiring first time information at which the voice signal is received and second time information at which the input is received, extracting data corresponding to the input, converting the voice signal to text data, and generating a response for the voice signal based on the text data, the first time information, the extracted data, and the second time information.

### BRIEF DESCRIPTION OF THE DRAWINGS

The above and other aspects, features and advantages of the present invention will be more apparent from the following detailed description when taken in conjunction with the accompanying drawings, in which:

FIG. 1A is illustrates a multimodal input according to an embodiment of the present invention;

FIG. 1B illustrates a multimodal input according to another embodiment of the present invention;

FIG. 1C is a timing diagram illustrating multimodal inputs according to another embodiment of the present invention;

FIG. 2 is a block diagram illustrating an electronic device according to an embodiment of the present invention;

FIG. 3 is a block diagram for processing a multimodal input in an electronic device according to an embodiment of the present invention;

FIG. 4 is a block diagram for processing a multimodal input in an electronic device according to another embodiment of the present invention;

FIG. 5 is a block diagram for processing a multimodal input in an electronic device and a server in cooperation with each other according to another embodiment of the present invention;

FIG. 6 is a flowchart illustrating of an operation of processing a multimodal input in an electronic device according to an embodiment of the present invention;

FIG. 7 is a flowchart illustrating of an operation of processing a multimodal input based on time information of multimodal input data in an electronic device according to an embodiment of the present invention;

FIG. 8 is a flowchart illustrating of a process of requesting analysis of multimodal input data by a server in an electronic device according to an embodiment of the present invention;

FIG. 9 is a flowchart illustrating of a process of analyzing multimodal input data in a server according to an embodiment of the present invention; and

FIGS. 10A to 10D are diagrams illustrating a multimodal input during execution of a map service application in an electronic device according to an embodiment of the present invention.

### DETAILED DESCRIPTION OF EMBODIMENTS OF THE PRESENT INVENTION

Embodiments of the present invention are described in detail hereinafter with reference to the accompanying drawings. Detailed descriptions of well-known functions or configurations are omitted since they would unnecessarily obscure the subject matter of the present invention. Also, the terms used herein are defined according to the functions of the present invention. Thus, the terms may vary depending on users' or operators' intentions or practices. Therefore, the terms used herein must be understood based on the descriptions made herein.

Embodiments of the present invention provide a technology of analyzing a relationship between input data using time information of the data input through various input to an electronic device. In particular, embodiments of the present invention provide a technology for determining a user's exact intent by analyzing a relationship between a voice command formulated in a natural language and data input through another input unit. For convenience of description, it is assumed that the data input through another input unit is data detected through a touch sensor (or a touchscreen). However, the data may be data input through other input units, such as, a keypad, a proximity-touch sensor, a motion detection sensor, and an illuminance sensor without departing from the scope of the present invention. For convenience of description, it is assumed that there is a multimodal input with respect to a map application providing a map service. However, embodiments of the present invention are applicable to multimodal inputs with respect to other executable applications in an electronic device without departing from the scope of the present invention.

In the present invention, the electronic device includes a portable electronic device, a portable terminal, a mobile terminal, a mobile pad, a media player, a Personal Digital Assistant (PDA), a desktop computer, a laptop computer, a smart phone, a netbook computer, a television (TV), a Mobile Internet Device (MID), an Ultra Mobile PC (UMPC), a tablet PC, a navigation system, and an MP3 player. Also, the electronic device includes any electronic device that includes functions of two or more of the above-identified electronic devices.

According to various embodiments of the present invention, when there are a plurality of demonstrative pronouns in a natural language query input in to an electronic device, the electronic device sets a relationship between the demonstrative pronouns and pieces of data input through other input units, precisely ascertaining an intent of a user without requesting requiring a user to set a relationship between pieces of input data to perform a relevant desired function and improving the user's input convenience making it more convenient for the user to input data.

An embodiment of the present invention determines whether there is a word requiring additional data in a natural language query when the natural language query is input to an electronic device and, when there is a word requiring additional data, determines the semantics of the word based on data input through other input units in the electronic device. For convenience of description, it is assumed that a demonstrative pronoun is a word requiring additional data. However, embodiments of the present invention are applicable to other types of words requiring additional data, for example, an ordinal number.

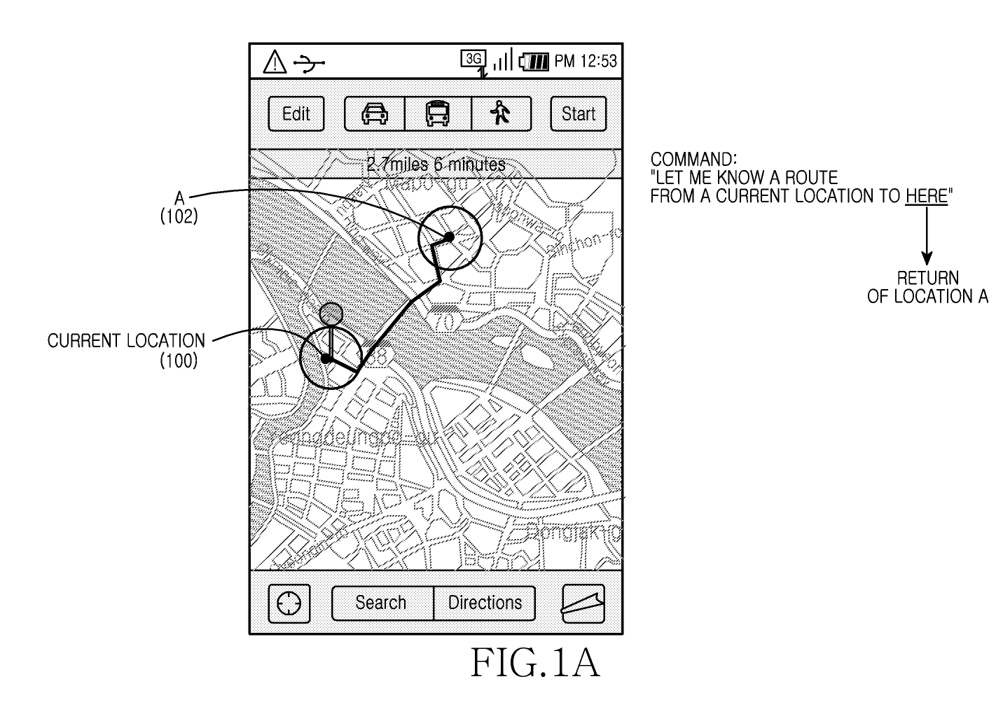

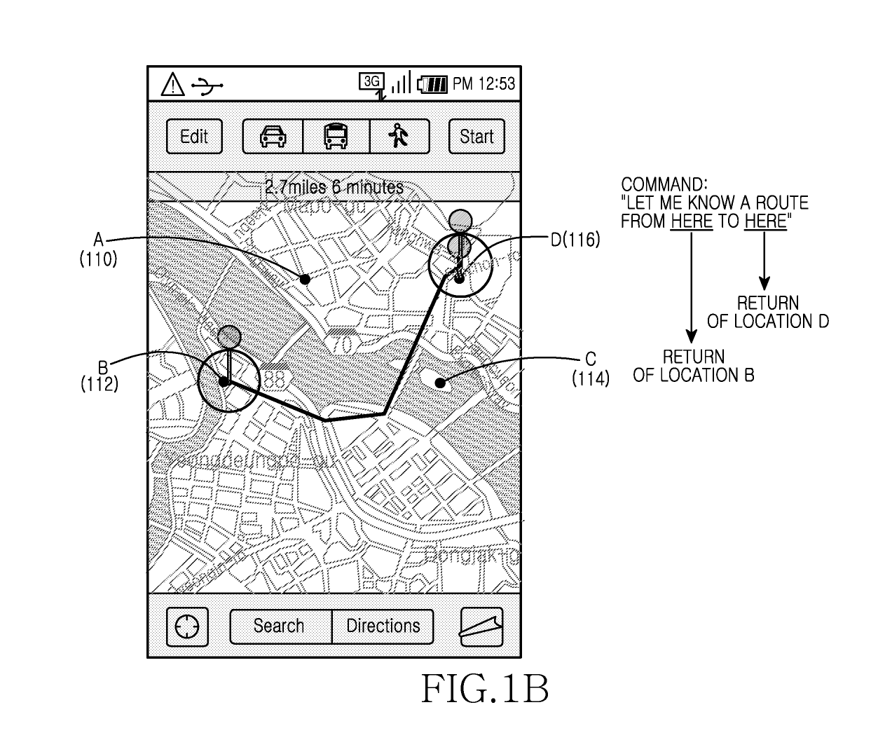

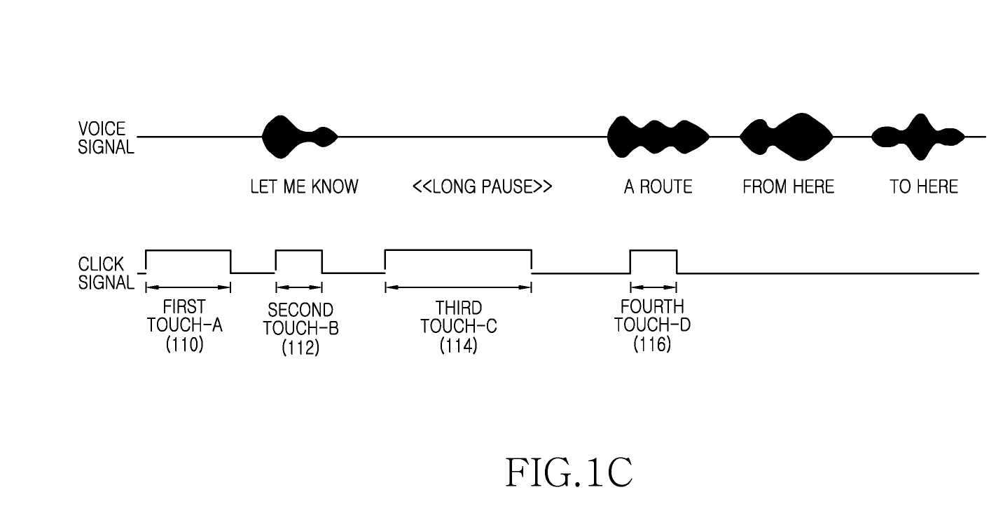

FIG. 1A illustrates a multimodal input according to an embodiment of the present invention. Referring to FIG. 1A, an electronic device receives a voice command “Let me know a route from a current location to here” that is formulated in a natural language from a user through a voice input device during execution of a map service application, and receives a touch on a location A 102 from the user through a touch sensor. The electronic device analyzes the voice command and determines that there is a demonstrative pronoun “here”. Then, the electronic device determines that the demonstrative pronoun “here” represents the location A 102 detected through the touch sensor that is another input unit. Then, the route from the current location 100 to the location A 102 indicating “here” is searched and provided to the user even though the user performs no additional setting operation for setting a relationship between the voice command and the touch input.

In another embodiment of the present invention, the electronic device determines whether there is a demonstrative pronoun in a natural language query, and when there is a plurality of demonstrative pronouns, determines what each of the demonstrative pronouns refers to based on data input through other input units. The electronic device determines what each of the demonstrative pronouns refers to, by using the input time information of each of the plurality of demonstrative pronouns and the input time information of the data input through the other input units.

FIG. 1B illustrates a multimodal input according to another embodiment of the present invention, and FIG. 1C illustrates timing at which the multimodal inputs are made according to another embodiment of the present invention.

Referring to FIG. 1B, an electronic device receives a voice command “Let me know a route from here to here” that is formulated in a natural language from a user through a microphone during execution of a map service application, and receives touches on locations A 110, B 112, C 114, and D 116 from the user through a touch sensor. When the electronic device determines that there are two demonstrative pronouns “here” after analysis of the voice command, the electronic device may determine which location of the locations A 110, B 112, C 114, and D 116 correspond to the two demonstrative pronouns “here” by comparing the input time of the two demonstrative pronouns with the touch time with respect to the locations A 110, B 112, C 114, and D 116 as illustrated in FIG. 1C. When the electronic device identifies that the location B 112 was touched at a time identical to the time at which the first demonstrative pronoun “here” was input, and that the location D 116 was touched at a time identical to the time at which the second demonstrative pronoun “here” was input, then the electronic device determines that the first demonstrative pronoun “here” represents the location B 112 and the second demonstrative pronoun “here” represents the location D 116. The input time of the demonstrative pronoun is the articulation time at which the demonstrative pronoun is articulated, or an input time at which the demonstrative pronoun is input to the electronic device. In addition, the input time of the demonstrative pronoun represents a time at which each syllable or phoneme (i.e., sub-text) is displayed for processing of an input voice command, that is, a time stamp value in the electronic device. The time identical to the time at which the demonstrative pronoun is input refers to a time, at which the numerical value is identical to that of a time at which the demonstrative pronoun is input, or a time which is within a predetermined time range determined with respect to the time at which the demonstrative pronoun is input. For example, when the demonstrative pronoun is input at 09:30:30, the electronic device recognizes touch data which is input at 09:30:30 as the data which is input at the identical time, or recognizes touch data which is input at 9:30:25 to 9:30:35 as the data which is input at the identical time.

When the location B 112 is “Samsung coffee shop” and the location D 116 is “Samsung hospital” in a map displayed on a screen, the electronic device determines that the first demonstrative pronoun “here” is “Samsung coffee shop” and the second demonstrative pronoun “here” is “Samsung hospital”, searches for a route from “Samsung coffee shop” to “Samsung hospital”, and provides the route to the user.

In this embodiment, since a touch on the location A and a touch on the location C were input at times different from the times which the first and second demonstrative pronouns were input, respectively, the electronic device determines that the locations A and C are not associated with the input voice command. The touches on the locations A and C may be touches generated when the user moved the map up, down, left or right to find a desired location.

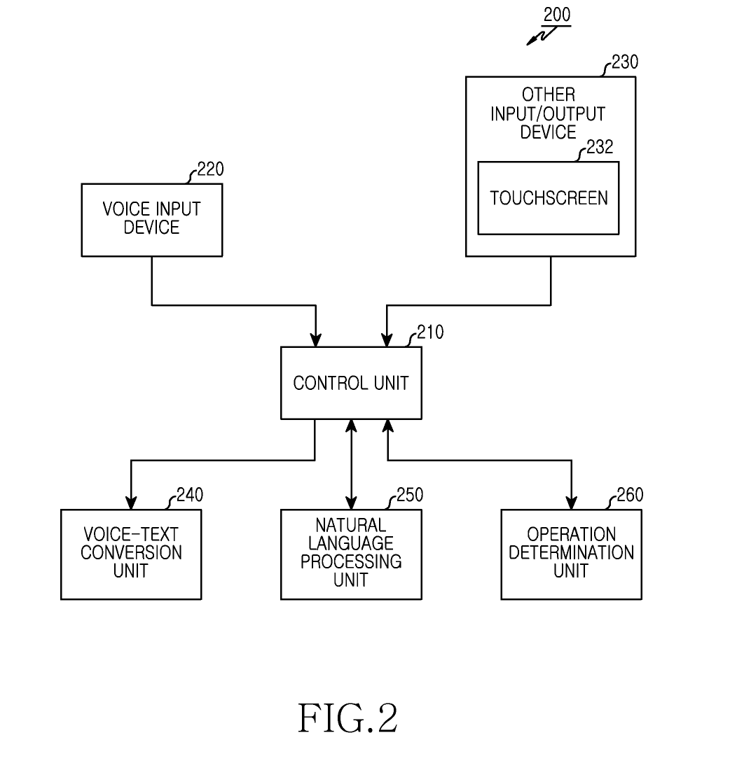

FIG. 2 is a block diagram configuration of an electronic device 200 according to an embodiment of the present invention.

Referring to FIG. 2, the electronic device 200 includes a control unit 210, a voice input device 220, another input/output device 230, a voice-text conversion unit 240, a natural language processing unit 250, and an operation determination unit 260. Although elements associated with the features of the present invention are described, it is obvious that other elements may be further included besides the illustrated elements.

The control unit 210 controls and processes the operation of the electronic device 200. The control unit 210 includes at least one processor and a peripheral interface for communicating with peripheral components. According to an embodiment of the present invention, the control unit 210 associates data input through different input units with one another to ascertain a user's intention, and performs control and processing for performing a function corresponding to the user's ascertained intention. For example, the control unit 210 determines a relationship between a voice command input through the voice input device 220 and touch data input through a touchscreen 232 of the other input/output device 230 by controlling and processing a function for ascertaining the user's intention with regard to these inputs.

Specifically, the control unit 210 provides the voice command input from the voice input device 220 to the voice-text conversion unit 240, and provides a text conversion result provided from the voice-text conversion unit 240 to the natural language processing unit 250. In this case, the text conversion result includes text of phonemes (i.e., sub-text) constituting the voice command and input time of each text or sub-text. When a text analysis result is provided from the natural language processing unit 250, the control unit 210 identifies the intent of the voice command, whether a demonstrative pronoun is included in the voice command, the number of demonstrative pronouns, text information corresponding to a demonstrative pronoun, and/or input time information of text corresponding to a demonstrative pronoun. The control unit 210 compares the input times of demonstrative pronouns with input times at which touch input data (coordinates at which touches are detected) are input through the touchscreen 232 and determines which demonstrative pronouns correspond to the touch input data, respectively. In this case, the control unit 210 identifies an application in which a touch input is generated among applications which are being executed, and determines data of the application corresponding to touch input data. For example, when a specific location on a map is touched by a user during display of a map on a screen, the electronic device 200 determines a point of interest (POI) corresponding to the touched location as data of an application corresponding to the touch input data. The control unit 210 provides the touch input data corresponding to each demonstrative pronoun and the intent of the voice command provided by the natural language processing unit 250 to the operation determination unit 260, receives information about the determined operational function of the electronic device 200 from the operation determination unit 260, and performs control and processing for the performance of the operational function.

The voice input device 220 receives a user's voice. The voice input device 220 includes a microphone. The voice input device 220 detects an endpoint of a voice signal by analyzing the input audio signal based on a known end point detection (EPD) method and provides the voice signal defined by the endpoint to the control unit 210.

The other input/output device 230 provides an external input from the user to the control unit 210 and output data generated by the electronic device 200 external to the electronic device 200. The other input/output device 230 includes a touchscreen 232. The touchscreen 232 includes a medium of detecting a touch input (for contact) of the user on the touch sensitive surface, transferring the detected touch input to the control unit 210, and providing a visual output from the control unit 210 to the user. The touchscreen 232 provides a visual output, such as text, graphic and video, to the user in response to the touch input. The touchscreen 232 detects a user touch input made through a haptic contact, a tactile contact, or a combination thereof. For example, a touch-detected point on the touchscreen 232 may correspond to the width of a finger used for contact with the touch sensitive surface. In addition, the touchscreen 232 detects contact by an external device, such as a stylus pen, through the touch sensitive surface. In addition, the other input/output device 232 includes a keypad, a button, a dial, a stick, and/or a pointer device, such as a stylus.

The voice-text conversion unit 240 converts a voice signal provided from the control unit 210 to text. The voice-text conversion unit 240 converts the voice signal to text by using a TTS (text to speech) function. The voice-text conversion unit 240 provides a text conversion result to the control unit 210.

The natural language processing unit 250 receives text corresponding to the voice command from the control unit 210, extracts a keyword by parsing the received text and syntactic and semantic analysis, and determines the intent of the voice command. In addition, the natural language processing unit 250 examines whether there is a demonstrative pronoun in the voice command through text analysis, and when there is a demonstrative pronoun, determines how many demonstrative pronouns exist. The natural language processing unit 250 provides a result of the text analysis including the intent of the voice command and information associated with the demonstrative pronoun to the control unit 210. The information associated with the demonstrative pronoun includes at least one of whether there is a demonstrative pronoun, the number of demonstrative pronouns, text information corresponding to the demonstrative pronoun, and input time information of text corresponding to the demonstrative pronoun. The natural language processing unit 250 analyzes the text based on known Natural Language Understanding (NLU) technologies.

The operation determination unit 260 receives the intent of the voice command from the control unit 210, determines an operational function of the electronic device 200 according to the intention, and provides information about the determined operational function to the control unit 210. Herein, the operational function refers to a function to be performed or operated by the electronic device 200 in response to the voice command from the user.

Although the voice-text conversion unit 240, the natural language processing unit 250, and the operation determining unit 260 are described as being separate elements, the functions of the voice-text conversion unit 240, the natural language processing unit 250, and the operation determining unit 260 may be performed by one element or by the control unit 210. Functions performed by respective devices constituting the electronic device 200 may be stored in a memory of the electronic device 200 in program form, or be performed by the control unit 210. According to the present invention, the functions of the voice-text conversion unit 240, the natural language processing unit 250, and the operation determining unit 260 may be performed by a server external to the electronic device 200.

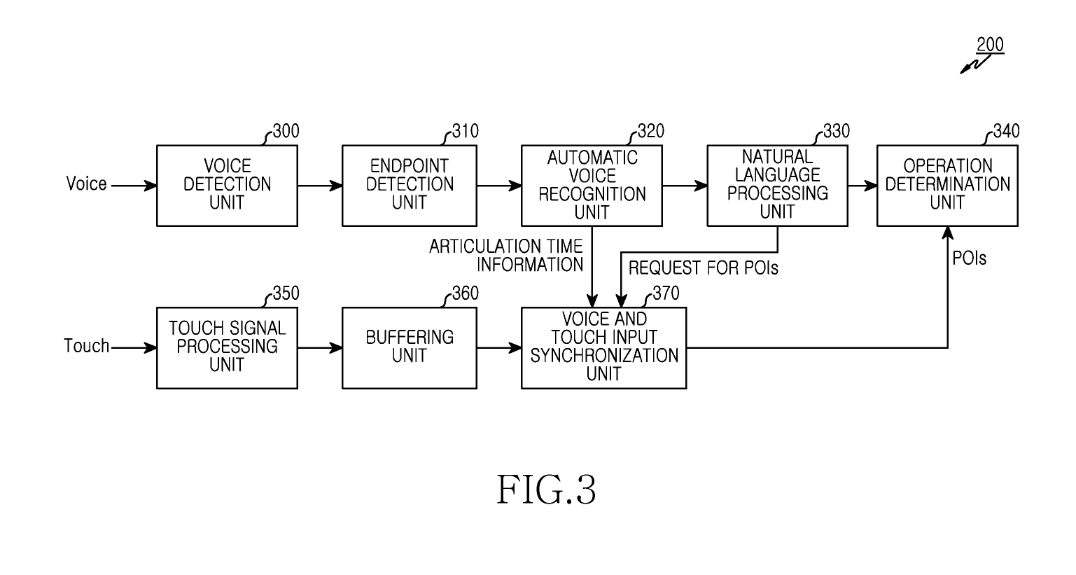

According to various embodiments of the present invention, the electronic device 200 includes elements as illustrated in FIGS. 3 to 5 and performs a function corresponding to a multimodal input, that is, data input through various input units. The description below assumes that a user's voice is input and a touch input is detected during execution of a map service application.

FIG. 3 is a block diagram configuration for processing a multimodal input in an electronic device 200 according to an embodiment of the present invention.

Referring to FIG. 3, the electronic device 200 includes a voice detection unit 300, an endpoint detection unit 310, an automatic voice recognition unit 320, a natural language processing unit 330, an operation determination unit 340, a touch signal processing unit 350, a buffering unit 360, and a voice and touch input synchronization unit 370.

The voice detection unit 300 receives a user's voice and inputs the user's voice to the endpoint detection unit 310. The endpoint detection unit 310 detects an endpoint of a voice signal based on a known End Point Detection (EPD) method and provides the voice signal defined by the endpoint to the automatic voice recognition unit 320.

The automatic voice recognition unit 320 converts the voice signal provided from the endpoint detection unit 310 to text. The automatic voice recognition unit 320 converts the voice signal to text by using a TTS (text to speech) function. The automatic voice recognition unit 320 provides a text conversion result to the voice and touch input synchronization unit 370. In this case, the text conversion result includes text of phonemes (i.e., sub-text) constituting the voice command and input time information of each text and sub-text. The input time information of each text and sub-text is the articulation time information of each text and sub-text.

The natural language processing unit 330 receives a text corresponding to the voice command from the automatic voice recognition unit 320, extracts a keyword by analyzing the received text, and ascertains the intent of the voice command. In addition, the natural language processing unit 330 examines whether there is a demonstrative pronoun in the voice command by analyzing the text, and when there is a demonstrative pronoun, determines how many demonstrative pronouns exist. The natural language processing unit 330 provides a signal indicating that additional information is required with respect to the demonstrative pronouns included in the voice command to the voice and touch input synchronization unit 370. The signal indicating that additional information is required with respect to the demonstrative pronouns includes text information constituting the demonstrative pronoun and/or input time information corresponding to the demonstrative pronoun. For example, when text corresponding to a voice command “Let me know a route from here to here” is received from the automatic voice recognition unit 320 during execution of a map service application, the natural language processing unit 330 determines that location information (or point-of-interest (POI) information) is required with respect to the first and second demonstrative pronouns, and provides text information and input time information corresponding to the first demonstrative pronoun “here” and the second demonstrative pronoun “here” to the voice and touch input synchronization unit 370.

The touch signal processing unit 350 detects a touch input by a user on the touch sensitive surface of the electronic device 200, and generates information of a touch input location and a touch input time. The touch signal processing unit 350 provides the generated information about the touch input location and the touch input time to the buffering unit 360. The buffering unit 360 buffers information provided by the touch signal processing unit 350 during input of voice, and when the input of voice is finished, provides the buffered information to the voice and touch input synchronization unit 370. That is, the buffering unit 360 receives the information about the touch input location and the touch input time from the touch signal processing unit 350 and buffers the same until the endpoint detection unit 310 detects an endpoint. When the endpoint detection unit 310 detects the endpoint, the buffering unit 360 provides the buffered information to the voice and touch input synchronization unit 370. For example, the buffering unit 360 receives and buffers information about touch input locations and touch input times generated during input of a voice command “Let me know a route from here to here”, and thereafter, outputs the buffered information when the input of the voice command is finished.

The voice and touch input synchronization unit 370 receives the text conversion result corresponding to the voice command from the automatic voice recognition unit 320, receives information about demonstrative pronouns requiring additional information from the natural language processing unit 330, and receives the information about touch input locations and touch input times from the buffering unit 360.

The voice and touch input synchronization unit 370 compares the input time information of the demonstrative pronouns requiring additional information with touch input time information and determines touch input locations corresponding to the demonstrative pronouns. The voice and touch input synchronization unit 370 determines a location at which the touch input is detected at a time identical to a time at which the demonstrative pronoun is input. For example, when the input time information of the first demonstrative pronoun “here” is 0 to 500 msec, the input time information of the second demonstrative pronoun “here” is 1,000 to 1,500 msec, and the touch input times of the three touch input locations A, B and C are, respectively, 0 to 300 msec, 600 to 700 msec, and 900 to 1,500 msec, the voice and touch input synchronization unit 370 determines the touch input location A as the touch input location corresponding to the first demonstrative pronoun “here”, and the touch input location B as the touch input location corresponding to the second demonstrative pronoun “here”. The voice and touch input synchronization unit 370 provides touch input location information corresponding to the demonstrative pronouns to the operation determination unit 340. In this case, the voice and touch input synchronization unit 370 provides the touch input locations corresponding to the demonstrative pronouns to the operation determination unit 340 as the touch coordinates thereof, and converts the touch coordinates to application data corresponding to the touch coordinates to provide the same to the operation determination unit 340. For example, when the map service application is being executed, the voice and touch input synchronization unit 370 provides any one of map latitude/longitude information corresponding to the touch coordinates or POI information corresponding to the latitude/longitude of the touch coordinates to the operation determination unit 340.

The operation determination unit 340 receives the intension and keyword of the voice command from the natural language processing unit 330 and additional information for the demonstrative pronouns from the voice and touch input synchronization unit 370, and determines an operational function of the electronic device 200 using the intension, the keyword, and/or the additional information for the demonstrative pronouns. For example, the operation determination unit 340 receives information indicating that the intent of the voice command is to search for a route from a location indicated by the first demonstrative pronoun “here” to a location indicated by the second demonstrative pronoun “here” from the natural language processing unit 360 and receives information indicating that a POI corresponding to the first demonstrative pronoun “here” is “Samsung coffee shop” and a POI corresponding to the second demonstrative pronoun “here” is “Samsung hospital” from the voice and touch input synchronization unit 370. In this case, the operation determination unit 340 determines the performance of an operation of searching for a route from “Samsung coffee shop” to “Samsung hospital” and an operation of displaying the searched route. When the additional information provided from the voice and touch input synchronization unit 370 is touch coordinates rather than application data, the operation determination unit 340 converts the touch coordinates to application data based on the application being executed and determines an operational function of the electronic device 200 based on the application data.

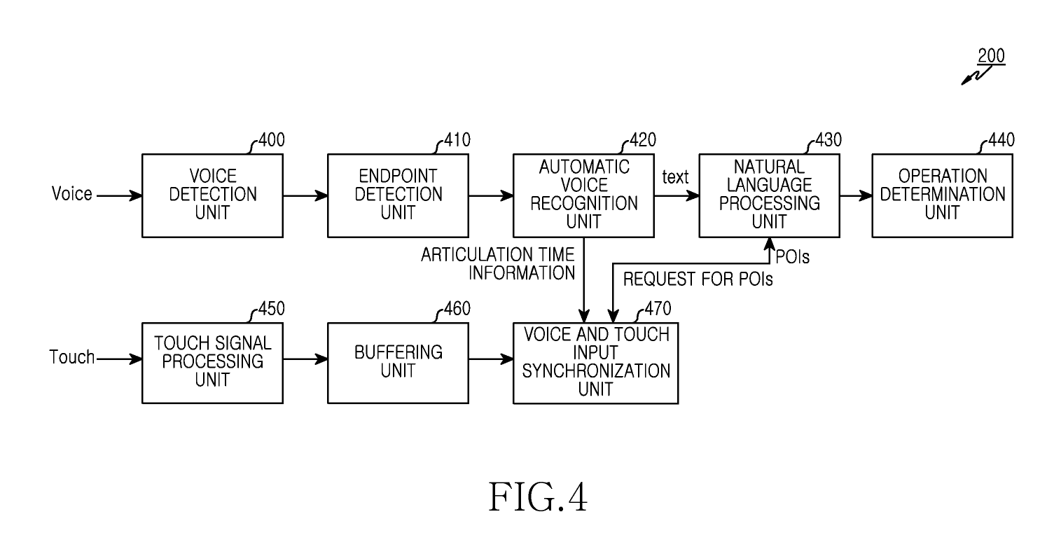

FIG. 4 is a block diagram configuration for processing a multimodal input in an electronic device 200 according to another embodiment of the present invention.

Referring to FIG. 4, the electronic device 200 includes a voice detection unit 400, an End Point Detection unit 410, an automatic voice recognition unit 420, a natural language processing unit 430, an operation determination unit 440, a touch signal processing unit 450, a buffering unit 460, and a voice and touch input synchronization unit 470.

The voice detection unit 400 receives a user's voice and inputs the user's voice to the endpoint detection unit 410. The endpoint detection unit 410 detects an endpoint of a voice signal based on a known End Point Detection (EPD) method and provides the voice signal defined by the endpoint to the automatic voice recognition unit 420.

The automatic voice recognition unit 420 converts the voice signal provided by the endpoint detection unit 410 to text. The automatic voice recognition unit 420 converts the voice signal to text using a TTS (text to speech) function. The automatic voice recognition unit 420 provides a voice-text conversion result to the voice and touch input synchronization unit 470. In this case, the text conversion result includes text of phonemes constituting the voice command and input time information of each text. The input time information of each text and sub-text is the articulation time information of each text and sub-text.

The natural language processing unit 430 receives text corresponding to the voice command from the automatic voice recognition unit 420, extracts a keyword by analyzing the received text, and ascertains the intent of the voice command. In addition, the natural language processing unit 430 examines whether there is a demonstrative pronoun in the voice command by analyzing the text, and when there is a demonstrative pronoun, determines how many demonstrative pronouns exist. The natural language processing unit 430 provides a signal indicating that additional information is required with respect to the demonstrative pronouns included in the voice command to the voice and touch input synchronization unit 470.

In addition, the natural language processing unit 430 determines an intent of the voice command based on additional information associated with the demonstrative pronouns which is provided by the voice and touch input synchronization unit 470. When a specific word is a homonym or a polysemy as a result of text analysis, and therefore may have several meanings, the natural language processing unit 430 determines the meaning of the specific word based on the additional information associated with the demonstrative pronoun provided from the voice and touch input synchronization unit 470. For example, when the voice command is “Let me know a bridge closest to here”, “bridge” may be interpreted as being a card game or a structure spanning and providing passage over a river, chasm, road, or the like. In this case, when the additional information corresponding to the demonstrative pronoun “here” which is provided by the voice and touch input synchronization unit 470 represents geographical location information, the natural language processing unit 430 interprets “bridge” as a structure spanning and providing passage over a river, chasm, road, or the like.

The touch signal processing unit 450 detects a touch input by a user on the touch sensitive surface of the electronic device 200, and generates information of a touch input location and a touch input time. The touch signal processing unit 450 provides the generated information about the touch input location and the touch input time to the buffering unit 460. The buffering unit 460 buffers information provided by the touch signal processing unit 450 during input of voice, and when the input of voice is finished, provides the buffered information to the voice and touch input synchronization unit 470. That is, the buffering unit 460 receives the information about the touch input location and the touch input time from the touch signal processing unit 450 and buffers the same until the endpoint detection unit 410 detects an endpoint. When the endpoint detection unit 410 detects the endpoint, the buffering unit 360 provides the buffered information to the voice and touch input synchronization unit 470.

The voice and touch input synchronization unit 470 receives the text conversion result corresponding to the voice command from the automatic voice recognition unit 420, receives information about a demonstrative pronoun requiring additional information from the natural language processing unit 430, and receives the information about touch input locations and touch input times from the buffering unit 460.

The voice and touch input synchronization unit 470 compares the input time information of the demonstrative pronouns requiring additional information with touch input time information and determines touch input locations corresponding to the demonstrative pronouns. That is, the voice and touch input synchronization unit 470 determines a location at which the touch input is detected at a time identical to a time at which the demonstrative pronoun is input. For example, when the input time information of the demonstrative pronoun “here” is 0 to 400 msec and the touch input times of two touch input locations A and B are respectively 0 to 400 msec and 800 to 1000 msec, the voice and touch input synchronization unit 470 determines the touch input location A as the touch input location corresponding to the demonstrative pronoun “here”. When the number of demonstrative pronouns is one, and the number of touch input locations is one, the voice and touch input synchronization unit 470 determines the touch input location as additional information of the demonstrative pronoun without comparison of the input time of the demonstrative pronoun with the touch input time for the touch input location. The voice and touch input synchronization unit 470 provides touch input location information corresponding to the demonstrative pronoun to the natural language processing unit 430. In this case, the voice and touch input synchronization unit 470 converts the touch coordinates corresponding to the demonstrative pronoun to application data corresponding to the touch coordinates and provides the same to the natural language processing unit 430. For example, when the map service application is being executed, the voice and touch input synchronization unit 470 provides any one of map latitude/longitude information corresponding to the touch coordinates or POI information corresponding to the latitude/longitude of the touch coordinates to the natural language processing unit 430. In this case, provision of the application data corresponding to the touch coordinates to the natural language processing unit 430 by the voice and touch input synchronization unit 470 is for allowing the natural language processing unit 430 to accurately ascertain the intent of the voice command.

The operation determination unit 440 receives the intention and keyword of the voice command and/or additional information for the demonstrative pronoun from the natural language processing unit 430 and determines an operational function of the electronic device 200 using the intension, the keyword, and/or the additional information for the demonstrative pronoun. For example, when information indicating that the intent of the voice command is to search for a route from a location indicated by the demonstrative pronoun “here” to a bridge geographically closest thereto and information indicating that “here” is “Samsung Electronics Co., Ltd.” the operation determination unit 440 determines the performance of an operation of searching for a route from “Samsung Electronics Co., Ltd.” to a bridge geographically closest thereto and an operation of displaying the searched route.

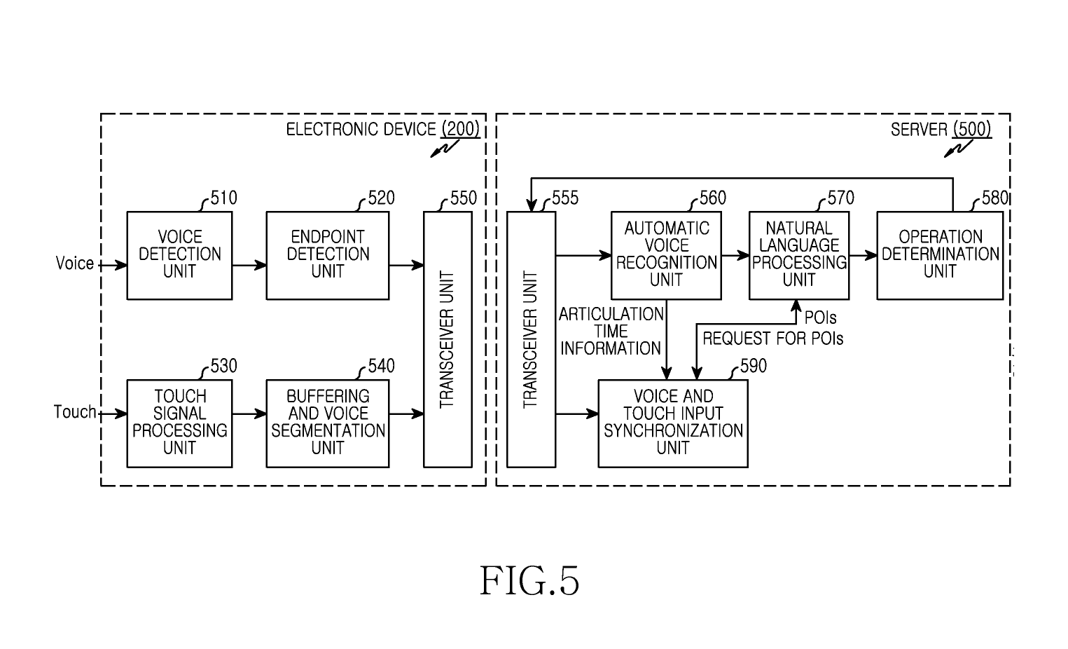

FIG. 5 is a block diagram configuration for processing a multimodal input in an electronic device 200 and a server 500 in cooperation with each other according to another embodiment of the present invention.

Referring to FIG. 5, the electronic device 200 includes a voice detection unit 510, an endpoint detection unit 520, a touch signal processing unit 530, a buffering and voice segmentation unit 540, and a transceiver unit 550, and the server 500 includes a transceiver unit 555, an automatic voice recognition unit 560, a natural language processing unit 570, an operation determination unit 580, and a voice and touch input synchronization unit 590.

The voice detection unit 510 of the electronic device 200 receives a user's voice and inputs the user's voice to the endpoint detection unit 520. The endpoint detection unit 520 detects an endpoint of a voice signal based on a known End Point Detection (EPD) method and provides the voice signal defined by the endpoint to the transceiver unit 550.

The touch signal processing unit 530 of the electronic device 200 detects a touch input by a user on the touch sensitive surface of the electronic device 200, and generates information of a touch input location and a touch input time. The touch signal processing unit 530 provides the generated information about the touch input location and the touch input time to the buffering and voice segmentation unit 540. The buffering and voice segmentation unit 540 buffers information provided from the touch signal processing unit 530 during input of voice, and when the input of voice is finished, provides the buffered information to the transceiver unit 550. The buffering and voice segmentation unit 540 receives the information about the touch input location and the touch input time from the touch signal processing unit 530 and buffers the same until the endpoint detection unit 520 detects an endpoint. When the endpoint detection unit 520 detects the endpoint, the buffering and voice segmentation unit 540 provides the buffered information to the transceiver unit 550. For example, the buffering and voice segmentation unit 540 receives and buffers information about touch input locations and touch input times generated during input of a voice command “Let me know a route from here to here”, and thereafter, outputs the buffered information when the input of the voice command is finished.

The transceiver unit 550 of the electronic device 200 transmits a voice signal provided from the endpoint detection unit 520 and information about the touch input locations and the touch input times provided from the buffering and voice segmentation unit 540 to the server 500 and requests the server 500 determine an operational function of the electronic device 200 corresponding to the voice signal. The transceiver unit 550 receives information about the operational function of the electronic device 200 from the server 500 and provides the received information to a control unit (or processor, not illustrated). The electronic device 200 communicates with the server 500 in a wireless or wired manner.

The transceiver unit 555 of the server 500 receives the voice signal and the information about the touch input locations and the touch input times from the electronic device 200, and provides the received voice signal to the automatic voice recognition unit 560 and the received information about the touch input locations and the touch input times to the voice and touch input synchronization unit 590. In addition, the transceiver unit 555 receives information about an operational function of the electronic device 200 from the operation determination unit 580 and transmits the received information about the operational function of the electronic device 200 to the electronic device 200.

The automatic voice recognition unit 560 converts the voice signal provided from the transceiver unit 555 to text. The automatic voice recognition unit 520 converts the voice signal to text by using a TTS (text to speech) function. The automatic voice recognition unit 560 provides a voice-text conversion result to the voice and touch input synchronization unit 590. In this case, the text conversion result includes text of phonemes constituting the voice command and input time information of each text and sub-text. The input time information of each text and sub-text is the articulation time information of each text and sub-text.

The natural language processing unit 570 receives text corresponding to the voice command from the automatic voice recognition unit 560, extracts a keyword by analyzing the received text, and ascertains the intent of the voice command. In addition, the natural language processing unit 570 examines whether there is a demonstrative pronoun in the voice command by analyzing the text, and when there is a demonstrative pronoun, determines how many demonstrative pronouns exist. The natural language processing unit 570 provides a signal indicating that additional information is required with respect to the demonstrative pronouns included in the voice command to the voice and touch input synchronization unit 590. The signal indicating that additional information is required with respect to the demonstrative pronouns includes text information constituting the demonstrative pronouns and/or input time information corresponding to the demonstrative pronouns. The natural language processing unit 570 ascertains an intent of the voice command based on additional information associated with the demonstrative pronouns which is provided from the voice and touch input synchronization unit 590. When a specific word is a homonymy or a polysemy as a result of text analysis, and therefore may be interpreted as having several meanings, the natural language processing unit 570 determines the meaning of the specific word based on the additional information associated with the demonstrative pronoun provided from the voice and touch input synchronization unit 590.

The voice and touch input synchronization unit 590 receives the text conversion result corresponding to the voice command from the automatic voice recognition unit 560, receives information about demonstrative pronouns requiring additional information from the natural language processing unit 570, and receives the information about touch input locations and touch input times from the buffering unit 460. The voice and touch input synchronization unit 590 compares the input time information of the demonstrative pronouns requiring additional information with touch input time information and determines touch input locations corresponding to the demonstrative pronouns. That is, the voice and touch input synchronization unit 590 determines a location at which the touch input is detected at a time identical to a time at which the demonstrative pronoun is input. The voice and touch input synchronization unit 590 provides touch input location information corresponding to the demonstrative pronouns to the natural language processing unit 570. In this case, the voice and touch input synchronization unit 590 converts the touch coordinates to application data corresponding to the touch coordinates in consideration of an application being executed in the electronic device 200 and provides the application data as touch input location information for the demonstrative pronouns.

The operation determination unit 580 receives the intention and keyword of the voice command and/or additional information for the demonstrative pronoun from the natural language processing unit 570 and determines an operational function of the electronic device 200 using the intension, the keyword, and/or the additional information for the demonstrative pronoun. The operation determination unit 580 provides information about the determined operational function of the electronic device 200 to the transceiver unit 555.

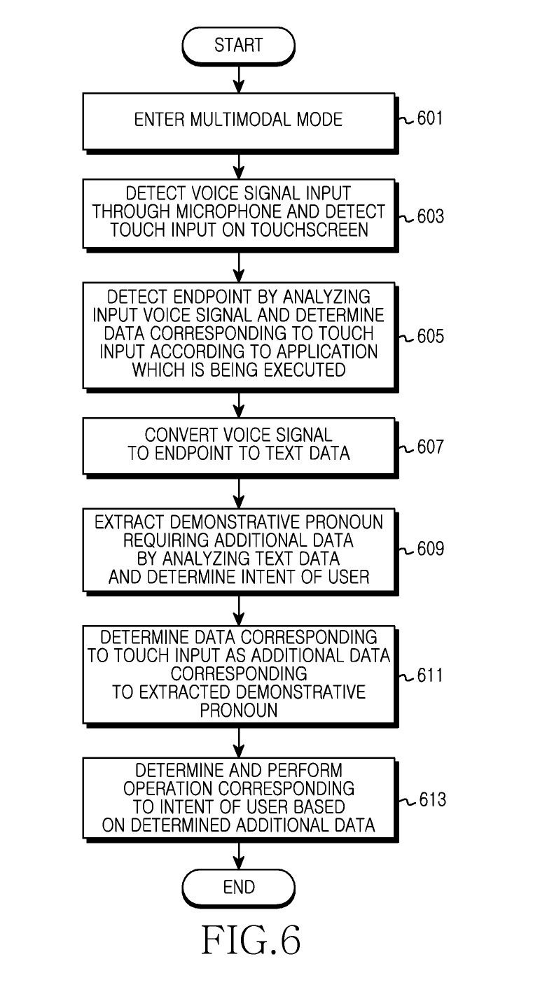

FIG. 6 is a flowchart of an operation of processing a multimodal input in an electronic device 200 according to an embodiment of the present invention. The description given below assumes that a voice signal and a touch input are provided as multimodal inputs, there is one demonstrative pronoun requiring additional data in the input voice signal, and the touch input is detected one time.

Referring to FIG. 6, in step 601, the electronic device 200 enters multimodal mode. The multimodal mode refers to a mode in which voice data formulated in a natural language and non-voice data are input together and are processed. In this case, the non-voice data includes data detected by a touch sensor, a proximity touch sensor, a keypad, a motion detection sensor, or an illuminance sensor.

In step 603, the electronic device 200 detects a voice signal input through a microphone and detects a touch input on a touchscreen. In step 605, the electronic device 200 detects an endpoint of the voice signal by analyzing the input voice signal input in step 605 and determines data corresponding to the touch input occurring in association with an application that is being executed. In this case, the electronic device 200 determines application data corresponding to the touch input occurring until the endpoint of the voice signal is detected, that is, during input of a voice command.

In step 607, the electronic device 200 converts the voice signal defined by the endpoint to text. In step 609, the electronic device 200 extracts a demonstrative pronoun requiring additional data through parsing of the text and syntactic and semantic analysis to ascertain a user's intention. In this case, when the intent of the voice command may be interpreted as having several meanings, the electronic device 200 ascertains the intent of the voice command based on additional data for the demonstrative pronoun after determination of the additional data for the demonstrative pronoun extracted in step 611 as described below.

In step 611, the electronic device 200 determines data of an application corresponding to the touch input as the additional data corresponding to the extracted demonstrative pronoun. For example, when a touch input is detected with respect to a map service application displayed on a screen of the electronic device 200, the electronic device 200 determines latitude/longitude information of the touch coordinates and POI information corresponding to the latitude/longitude of the touch coordinates as data corresponding to the touch input and determines the determined latitude/longitude information or the POI information as the additional data of the demonstrative pronoun.

In step 613, the electronic device 200 determines an operational function corresponding to the user's intent based on the determined additional data and performs the determined operational function. For example, in a case where the electronic device 200 executes a map service application and then displays a map, when a voice signal “Let me know a time required to travel from a current location to here” is input and a touch input is detected on a specific location of the displayed map, the electronic device 200 determines a POI corresponding to coordinates at which the touch input is detected as the meaning of “here”, and searches for a route from the current location of the electronic device 200 to the specific location. Thereafter, the electronic device 200 calculates a time required to travel through the searched route and displays the route and the required time.

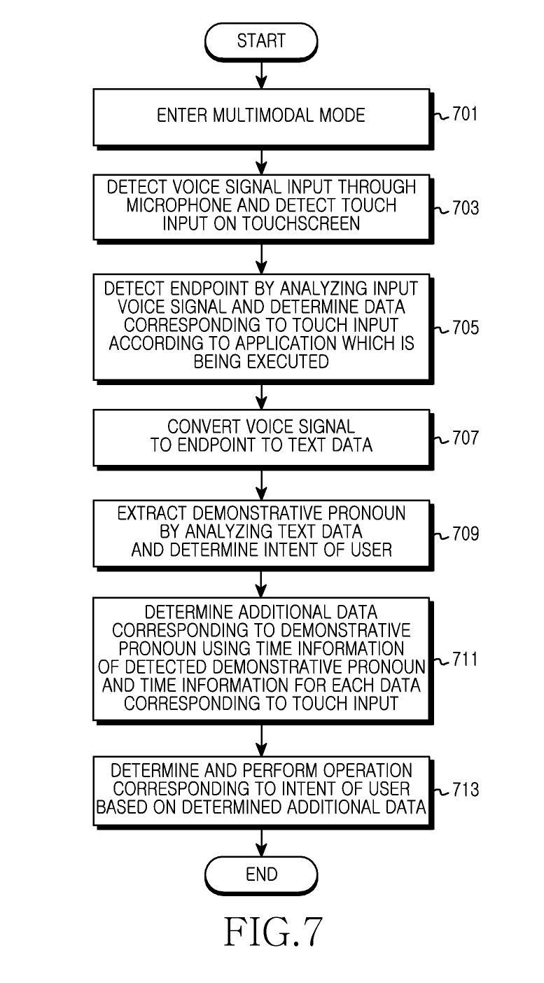

FIG. 7 is a flowchart illustrating an operation of processing a multimodal input based on time information of multimodal input data in an electronic device 200 according to an embodiment of the present invention. A description given below assumes that a voice signal and a touch input are provided as multimodal inputs, there is a plurality of demonstrative pronouns requiring additional data in the input voice signal, and the touch input is detected several times.

Referring to FIG. 7, the electronic device 200 enters multimodal mode in step 701. The multimodal mode refers to a mode in which voice data formulated in natural language and non-voice data are input together and are processed. In this case, the non-voice data includes data detected by a touch sensor, a proximity touch sensor, a keypad, a motion detection sensor, or an illuminance sensor.

In step 703, the electronic device 200 detects a voice signal input through a microphone and detects touch inputs on a touchscreen. In step 705, the electronic device 200 detects an endpoint of the voice signal by analyzing the input voice signal and determines data corresponding to the touch inputs occurring in association with an application being executed. In this case, the electronic device 200 determines application data corresponding to the touch inputs occurring until the endpoint of the voice signal is detected, that is, during input of a voice command.

In step 707, the electronic device 200 converts the voice signal defined by the endpoint to text. In step 709, the electronic device 200 extracts each demonstrative pronoun requiring additional data through parsing of the text and syntactic and semantic analysis to ascertain a user's intention. In this case, when the intent of the voice command is interpreted as having several meanings, the electronic device 200 ascertains the intent of the voice command based on additional data for the demonstrative pronouns after determination of the additional data for the demonstrative pronouns extracted in step 611 as described below.

In step 711, the electronic device 200 determines additional data corresponding to the demonstrative pronoun by using the time information of the extracted demonstrative pronouns and the time information for each data corresponding to each of the touch inputs. The time information of a demonstrative pronoun is the articulation time of the demonstrative pronoun or absolute time information representing a time at which the demonstrative pronoun is input to the electronic device 200, or is relative time information set based on a phoneme or syllable which is input first among phonemes or syllables constituting a voice command. The relative time information refers to a time at which each phoneme or syllable is displayed for processing of an input voice command, that is, a time stamp value in the electronic device 200. In addition, the time information for each data corresponding to each touch input refers to a time at which the touch input corresponding to the data is detected. The time at which the touch input is detected is relative time information representing a touch input time with respect to a time at which input of a voice command starts.

In step 713, the electronic device 200 determines an operational function corresponding to the user's intent based on the determined additional data and performing the determined operational function. For example, in a case where the electronic device 200 executes a map service application and then displays a map, when a voice signal “Let me know the shortest route from this place to here” is input and touch inputs are detected on locations A, B and C of the displayed map, the electronic device 200 compares the articulation time information of the demonstrative pronouns “this place” and “here” with the touch time information of the locations A, B and C to ascertain that “this place” is the location A and “here” is the location C. The electronic device 200 searches for various routes from the location A to the location C and calculates distances of the routes respectively. Thereafter, the electronic device 200 displays information about the shortest route.

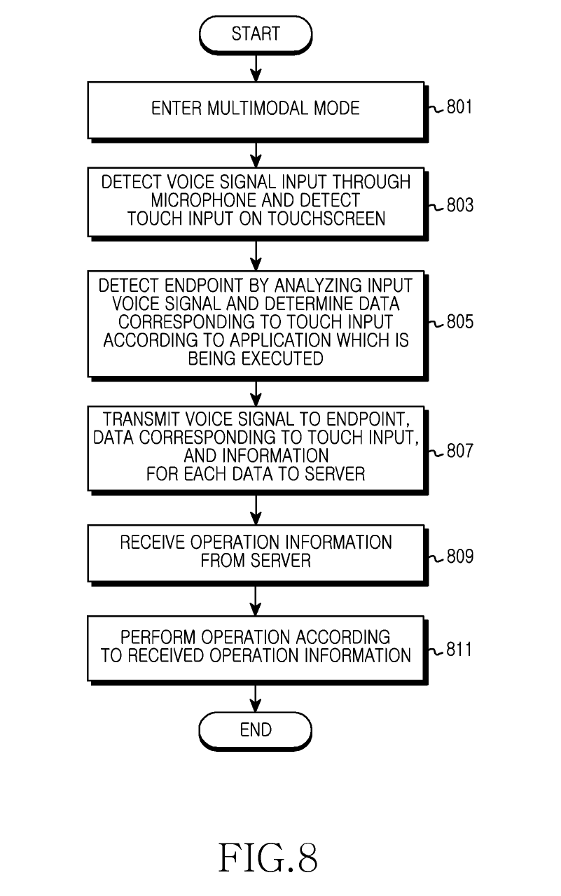

FIG. 8 is a flowchart of a process of requesting analysis of multimodal input data to a server 500 in an electronic device 200 according to an embodiment of the present invention. The description given below assumes that the electronic device 200 transmits received multimodal inputs to the server 500, and receives a result of analysis of the multimodal inputs from the server 500.

Referring to FIG. 8, the electronic device 200 enters multimodal mode in step 801. The multimodal mode refers to a mode in which voice data formulated in natural language and non-voice data are input together and are processed. In this case, the non-voice data includes data detected by a touch sensor, a proximity touch sensor, a keypad, a motion detection sensor, or an illuminance sensor.

In step 803, the electronic device 200 detects a voice signal input through a microphone and detects a touch input on a touchscreen. In step 805, the electronic device 200 detects an endpoint of the voice signal by analyzing the input voice signal and determines data corresponding to the touch input occurring in association with an application that is presently being executed. In this case, the electronic device 200 determines application data corresponding to the touch input occurring until the endpoint of the voice signal is detected, that is, during input of a voice command.

The electronic device 200 transmits the voice signal defined by the endpoint, data corresponding to the touch input, and information for each datum to the server 500 in step 807, and receives information about an operational function of the electronic device 200 from the server 500 in step 809. In step 811, the electronic device 200 operates according to the received operation information.

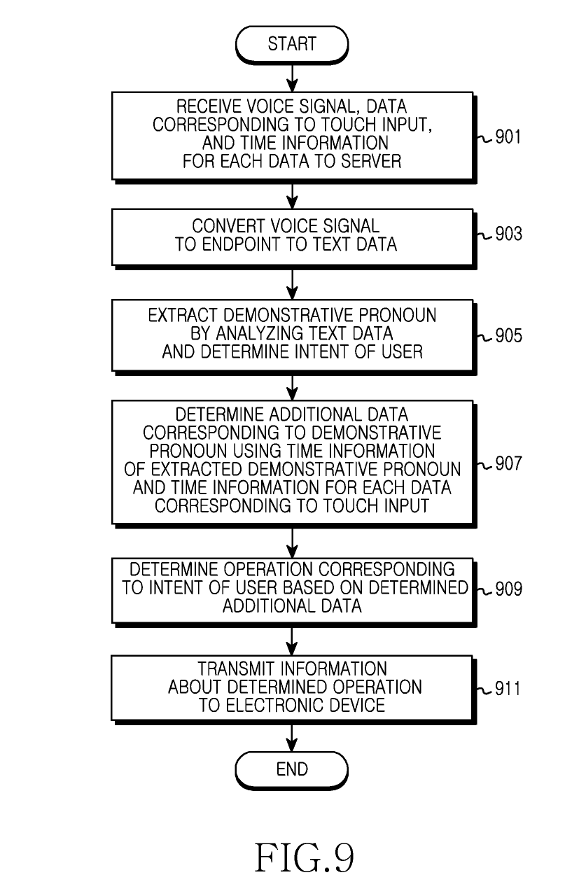

FIG. 9 is a flowchart of a process of analyzing multimodal input data in a server 500 according to an embodiment of the present invention. The description given below assumes that the server 500 receives and analyzes information associated with multimodal inputs.

Referring to FIG. 9, the server 500 receives a voice signal including a voice command, data corresponding to a touch input, and time information for each datum from the electronic device 200 in step 901. In step 903, the server 500 converts the received voice signal to text. In step 905, the server 500 extracts a demonstrative pronoun requiring additional data through parsing of the text and syntactic and semantic analysis to ascertain a user's intention. In this case, when the intent of the voice command is interpreted as having several meanings, the server 500 ascertains the intent of the voice command based on additional data for the demonstrative pronoun after determination of the additional data for the demonstrative pronoun extracted in step 907 as described below.

In step 907, the electronic device 200 determines additional data corresponding to the demonstrative pronoun by using the time information of the extracted demonstrative pronouns and the time information for each datum corresponding to each of the touch inputs. The time information of a demonstrative pronoun is the articulation time of the demonstrative pronoun or absolute time information representing a time at which the demonstrative pronoun is input to the electronic device 200, or is relative time information set based on a phoneme or syllable which is input first among phonemes or syllables constituting a voice command. The relative time information refers to a time at which each phoneme or syllable is displayed for processing of an input voice command, that is, a time stamp value in the electronic device 200. In addition, the time information for each datum corresponding to each touch input refers to a time at which the touch input corresponding to the data is detected. The time at which the touch input is detected is relative time information representing a touch input time with respect to a time at which input of a voice command starts.

In step 909, the server 500 determines an operational function corresponding to the user's intent based on the determined additional data and performs the determined operational function.

Although a voice command including a demonstrative pronoun is taken as an example in the above-described embodiments of the present invention for convenience of description, the embodiments may be applied to a voice command including at least one ordinal in the same manner. When there is an ordinal in the voice command, the electronic device 200 determines additional data for the ordinal by using order information representing the ordinal. For example, the order information indicated by the ordinal is compared with the input order of the coordinates at which touch inputs are detected to determine additional data corresponding to the ordinal.

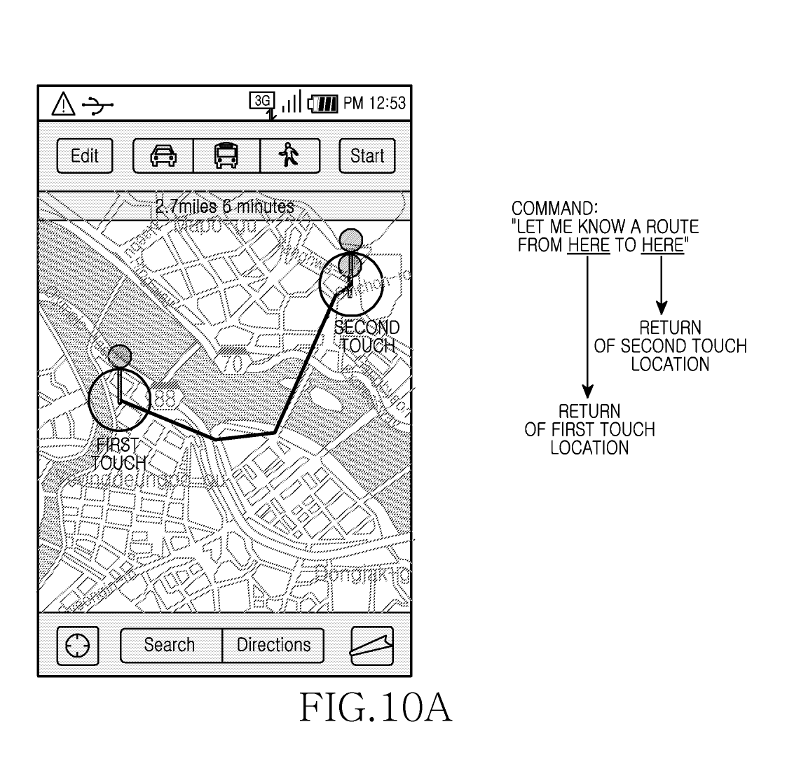

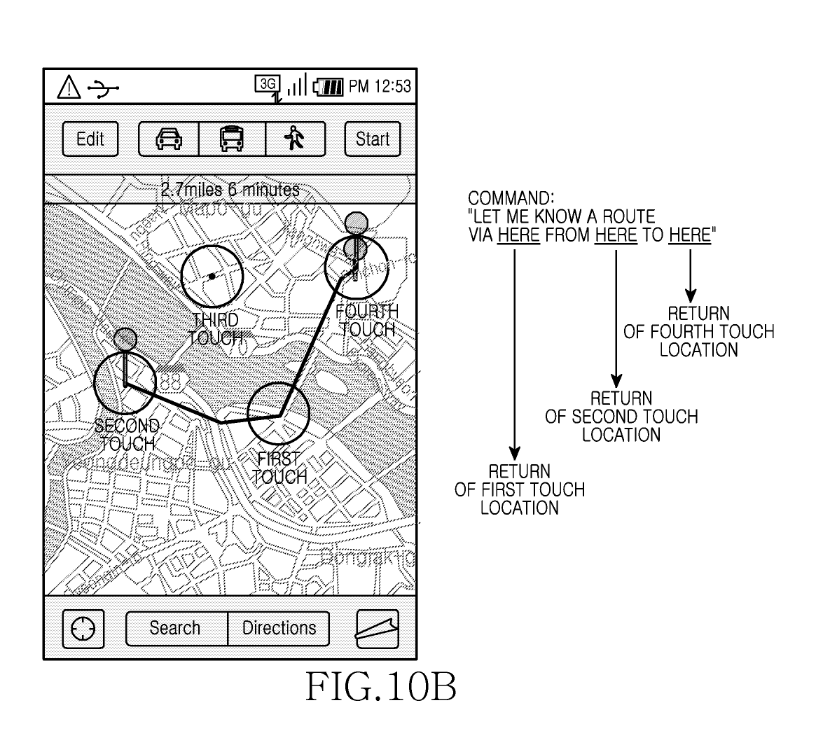

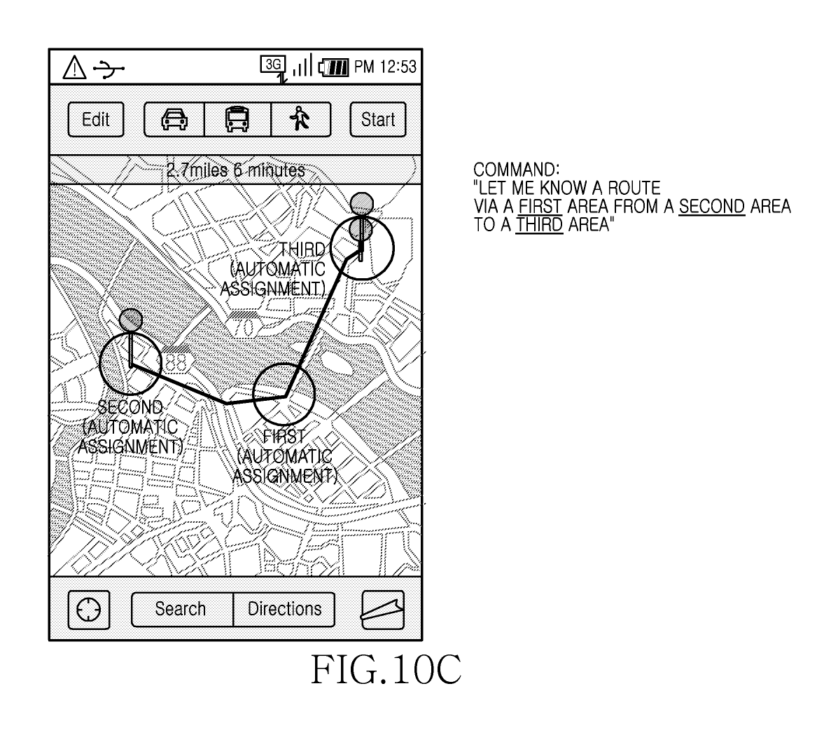

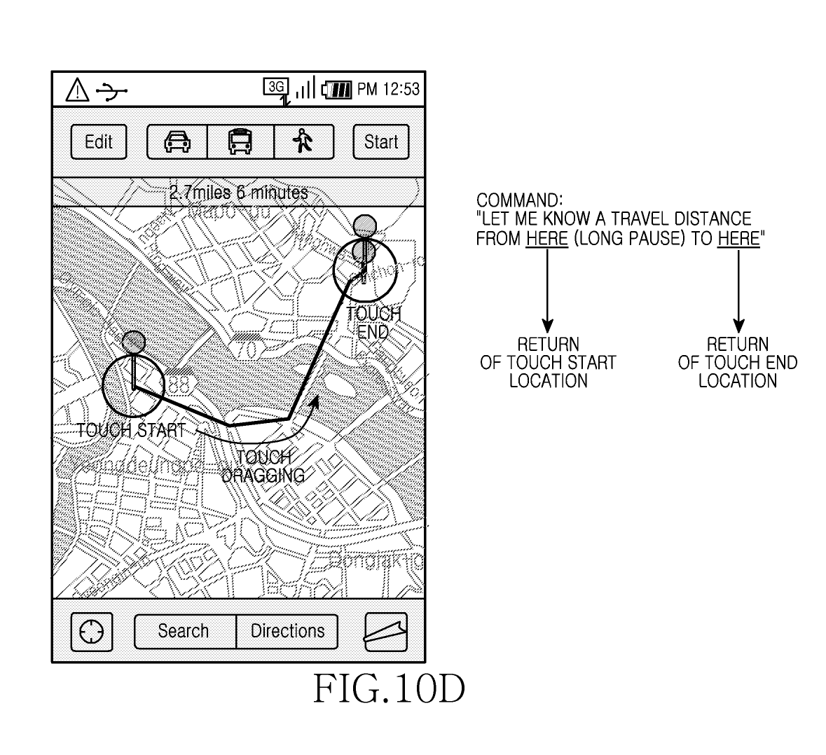

FIGS. 10A to 10D illustrate a multimodal input during execution of a map application in an electronic device according to an embodiment of the present invention.

Referring to FIG. 10A, the electronic device receives a voice command “Let me know a route from here to here” from a user during execution of a map service application and detects touch inputs on two locations in a displayed map. The electronic device detects that there are two demonstrative pronouns requiring additional data in the voice command and compares articulation time information of the two demonstrative pronouns with detection times at which touch inputs on two touch locations are detected. When the first touch input is detected at the articulation time of the first demonstrative pronoun “here”, and the second touch input is detected at the articulation time of the second demonstrative pronoun “here”, the electronic device determines the first touch location as the additional data of the first demonstrative pronoun “here” and determines the second touch location as the additional data of the second demonstrative pronoun “here”. Then, the electronic device searches for a route from the first touch location to the second touch location and provides the searched route to a user.

Referring to FIG. 10B, the electronic device receives a voice command “Let me know a route via here from here to here” from a user during execution of a map service application and detects touch inputs on four locations in a displayed map. The electronic device detects that there are three demonstrative pronouns requiring additional data in the voice command and compares articulation time information of the three demonstrative pronouns with detection times at which touch inputs on four touch locations are detected. When the first touch input is detected at the articulation time of the first demonstrative pronoun “here”, the second touch input is detected at the articulation time of the second demonstrative pronoun “here”, the third touch input is detected at a time after the articulation time of the second demonstrative pronoun and before the articulation time of the third demonstrative pronoun, and the fourth touch input is detected at the articulation time of the third demonstrative pronoun “here”, the electronic device determines the first touch location as the additional data of the first demonstrative pronoun “here”, determines the second touch location as the additional data of the second demonstrative pronoun “here”, and determines the fourth touch location as the additional data of the third demonstrative pronoun “here”. Then, the electronic device searches for a route from the second touch location via the first touch location to the fourth touch location and provides the searched route to a user. In this case, the electronic device determines that the third touch is a touch occurring when the user scrolls (or moves) a screen to find a desired location.

Referring to FIG. 10C, the electronic device receives a voice command “Let me know a route via a first area from a second area to a third area” from a user during execution of a map service application and detects touch inputs on three locations in a displayed map. In this case, the electronic device detects that there are three ordinals requiring additional data in the voice command, and compares the order indicated by the ordinals with the order in which the touch inputs are detected. The electronic device determines the first touch location as the additional data of the ordinal “first”, determines the second touch location as the additional data of the ordinal “second”, and determines the third touch location as the additional data of the ordinal “third”. Then, the electronic device searches for a route via the first touch location from the second touch location to the third touch location and provides the searched route to a user.

Referring to FIG. 10D, the electronic device receives a voice command “Let me know a travel distance from here to here” from a user during execution of a map service application, and detects that a touch is made at a specific location on the display map, is dragged, and is finished at a different location. The electronic device detects that there are two demonstrative pronouns requiring additional data in the voice command, and compares articulation time information of the two demonstrative pronouns with touch occurrence times and touch end times. When the articulation time of the first demonstrative pronoun is identical to the touch occurrence time, and the articulation time of the second demonstrative pronoun is identical to the touch end time, the electronic device determines the touch occurrence location as the additional data of the first demonstrative pronoun and determines the touch end location as the additional data of the second demonstrative pronoun. The electronic device maintains one touch during generation of two demonstrative pronouns, and the voice command requires the travel distance between the two demonstrative pronouns, thereby setting dragged locations as a travel route. Then, the electronic device calculates a distance to the touch end location by setting the dragged locations as the travel route and provides the calculated distance to the user.

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method in an electronic device, the method comprising:
receiving a voice signal and an input;
extracting data corresponding to the input;
converting the voice signal to text data;
setting an association relationship between the converted text data and the extracted data; and
generating a response for the voice signal based on the converted text data, the extracted data, and the set association relationship.

2. The method of claim 1, further comprising:
acquiring first time information at which the voice signal is received; and
acquiring second time information at which the input is received,
wherein the association relationship between the text data and the extracted data is set using the first time information and the second time information.

3. The method of claim 2, wherein setting the association relationship between the text data and the extracted data comprises:
identifying at least one sub-text data requiring additional information from the text data;
extracting third time information corresponding to the at least one sub-text data from the first time information at which the voice signal is received; and
setting the association relationship between the at least one sub-text data and the extracted data based on the second time information and the third time information.

4. The method of claim 3, wherein setting the association relationship between the at least one sub-text data and the extracted data based on the second time information and the third time information comprises:
determining data associated with the at least one sub-text data among the extracted data based on the second time information and the third time information; and
setting the determined data as the additional data associated with the at least one sub-text data.

5. The method of claim 1, wherein setting the association relationship between the text data and the extracted data comprises:
identifying at least one sub-text data requiring additional information from the text data; and
setting an association relationship between the at least one sub-text data and the extracted data.

6. The method of claim 5, wherein the sub-text data includes at least one word representing a demonstrative pronoun and an order.

7. The method of claim 6, wherein setting the association relationship between the at least one sub-text data and the extracted data comprises:
determining an order of data corresponding to the input when the sub-text data is a word representing an order; and
setting an association relationship between the sub-text and the extracted data based on the determined order.

8. The method of claim 1, wherein extracting the data corresponding to the input comprises:
identifying an application during display in the electronic device; and
extracting data of the application corresponding to the input.

9. The method of claim 1, wherein generating the response for the voice signal based on the text data, the extracted data, and the set association relationship comprises:
analyzing the text data;
determining a meaning of the text data based on the extracted data when there is text data having a plurality of meanings in the text data;
determining an intent of the text data based on the determined meaning, the text data, the extracted data, and the set association relationship; and
generating a response corresponding to the determined intention.

10. A method for operating an electronic device, comprising:
receiving a voice signal;
storing first time information at which the voice signal is received;
receiving an input;
storing second time information corresponding to the input;
extracting data corresponding to the input;
converting the voice signal to text data; and
generating a response for the voice signal based on the text data, the first time information, the extracted data, and the second time information.

11. An electronic device comprising:
a voice input device configured to receive a voice signal;
another input device configured to receive an input; and
a control unit configured to extract data corresponding to the input, convert the voice signal to text data, set an association relationship between the text data and the extracted data, and generate a response for the voice signal based on the text data, the extracted data, and the set association relationship.

12. The electronic device of claim 11, wherein
the control unit acquires first time information at which the voice signal is received, and second time information at which the input is received, and
the association relationship between the text data and the extracted data is set using the first time information and the second time information.

13. The electronic device of claim 12, wherein the control unit identifies at least one sub-text data requiring additional information from the text data, extracts third time information corresponding to the at least one sub-text data from the first time information at which the voice signal is received, and sets the association relationship between the at least one sub-text data and the extracted data based on the second time information and the third time information.

14. The electronic device of claim 13, wherein the control unit determines data associated with the at least one sub-text data among the extracted data based on the second time information and the third time information, and sets the determined data as the additional data associated with the at least one sub-text data.

15. The electronic device of claim 11, wherein the control unit identifies at least one sub-text data requiring additional information from the text data, and sets an association relationship between the at least one sub-text data and the extracted data.

16. The electronic device of claim 15, wherein the sub-text data includes at least one of words representing a demonstrative pronoun and an order.

17. The electronic device of claim 16, wherein the control unit determines an order of data corresponding to the input when the sub-text data is a word representing an order, and sets an association relationship between the sub-text data and the extracted data based on the determined order.

18. The electronic device of claim 11, wherein the control unit identifies an application during display in the electronic device, and extracts data of the application corresponding to the input.

19. The electronic device of claim 11, wherein the control unit analyzes the text data, determines a meaning of the text data based on the extracted data when there is text data having a plurality of meanings in the text data, determines an intent of the text data based on the determined meaning, the text data, the extracted data, and the set association relationship, and generates a response corresponding to the determined intention.

20. An electronic device comprising:
a voice input device configured to receive a voice signal;
an input device configured to receive an input; and
a control unit configured to acquire first time information at which the voice signal is received and second time information at which the input is received, extract data corresponding to the input, convert the voice signal to text data, and generate a response for the voice signal based on the text data, the first time information, the extracted data, and the second time information.
